(19) United States
(12) Patent Application Publication
(10) Pub. No.: US 2016/0357505 A1
(43) Pub. Date: Dec. 8, 2016

(54) Adaptive Sound Fuel Dispensing Devices and Methods

(71) Applicant: Wayne Fueling Systems LLC, Austin, TX (US)

(72) Inventor: Bengt I. Larsson, Skivarp (SE)

(21) Appl. No.: 14/733,218

(22) Filed: Jun. 8, 2015

(51) Int. Cl. G06F 3/16; G05B 15/02; B67D 7/04

(52) U.S. Cl. CPC G06F 3/165; B67D 7/04; G05B 15/02

(57) ABSTRACT

Methods, systems, and devices are provided for adapting sound in fuel dispensing devices. A fuel dispenser is provided for dispensing fuel to a vehicle including a housing base, a hose with a nozzle coupled to the housing, a control system in the housing for controlling the dispensing of fuel into a vehicle, and an electronics module. A graphical display is located on the electronics module for presenting audio and video information to a customer. The graphical display is configured to detect surrounding noise and to adjust a volume of the audio information accordingly. The volume can also be adjusted upon actuation of a trigger and/or continuously. At least one transducer can be provided that is coupled to the trigger and to the graphical display. A transducer being configured to continuously detect surrounding noise can also be provided coupled to the graphical display.

### FIELD

Methods, systems, and devices are provided for adapting sound in fuel dispensing devices.

### BACKGROUND

Fuel dispensing devices often play audio and/or video to any customers using the devices. This practice is beneficial both to owners of the fuel dispensing devices and to customers. The customers can receive information and the owners of the fuel dispensing devices are able to effectively communicate information about any number of topics, for example, safe operation of the fuel dispensing devices and/or commercial promotions applicable to the customers.

However, noise levels surrounding the fuel dispensing devices may prevent an effective exchange of information between the customers and the fuel dispensing devices. For example, during busy times at a fueling station with fuel dispensing devices, the noise levels of other customers, vehicles, and any operations at the station may prevent a customer from effectively hearing audio information output by a fuel dispensing device. Further, any noises caused by activity surrounding the station, such as traffic or other businesses, may exacerbate the difficulty of a customer to hear audio information. But simply increasing a volume of the audio information is not effective in environments that may be quieter at certain times of the day. For example, outputting audio information at a loud volume in the middle of the night may disturb both the customer using the fuel dispensing device and surrounding businesses or homes.

Thus a need exists for a fuel dispensing device that is capable of adapting an output volume of the audio.

### SUMMARY

Methods, systems, and devices are provided for adapting sound at a fuel dispensing device.

In one embodiment, a fuel dispenser is provided for dispensing fuel to a vehicle. The fuel dispenser has a housing and a hose coupled to the housing and having a nozzle located on a terminal end thereof. A control system is provided in the housing for controlling the dispensing of fuel through the hose and the nozzle. A graphical display is located on the housing for presenting information to a customer, comprising audio and video information. The graphical display is configured to detect surrounding noise and to adjust a volume of the audio information in response to the detected surrounding noise.

In various embodiments, the graphical display can include a transducer that emits the audio information. The transducer can be a membrane speaker. The graphical display can also include a transducer for detecting the surrounding noise. The graphical display can include a single transducer for detecting the surrounding noise and for emitting the audio information.

In another embodiment, a fuel dispenser for dispensing fuel to a vehicle is provided having a housing and a hose coupled to the housing and having a nozzle located on a terminal end thereof. A control system is provided in the housing for controlling the dispensing of fuel through the hose and the nozzle into a vehicle. A graphical display is located on the housing for presenting information to a customer, comprising audio and video information. A trigger is provided that is capable of activating the graphical display to cause the graphical display to present information to the customer. At least one transducer is coupled to the trigger and to the graphical display. The transducer is configured to detect surrounding noise in response to actuation of the trigger. The graphical display is configured to adjust a volume of the audio information in response to the detected surrounding noise.

In some embodiments, the transducer can be a speaker that emits the audio information. The speaker can be a membrane speaker. The transducer can be a single transducer for detecting the surrounding noise and for emitting the audio information. The trigger can be configured to be actuated upon the customer interacting with the graphical display. Additionally, the information can be a continual predetermined loop of audio and video information, and an end of each loop can function as the trigger to activate the graphical display.

In another embodiment, a fuel dispenser for dispensing fuel to a vehicle is provided having a housing and a hose coupled to the housing and having a nozzle located on a terminal end thereof. The housing has a control system in the housing for controlling the dispensing of fuel through the hose and the nozzle into a vehicle. A graphical display is located on the housing for presenting information to a customer, comprising audio and video information. At least one transducer is coupled to the graphical display and is configured to continuously detect surrounding noise. The graphical display is configured to adjust a volume of the audio information in response to the detected surrounding noise.

In other embodiments, the transducer can be a speaker that emits the audio information. The speaker can be a membrane speaker. The transducer can be at least one transducer configured to detect the surrounding noise, and the graphical display can include at least one additional transducer for emitting the audio information.

In one embodiment, a fuel delivery system for fueling a vehicle is provided having a fuel dispenser assembly operatively arranged to controllably dispense fuel into a vehicle positioned for refueling. The system also has a control assembly operatively arranged to control a fuel dispensing activity of the fuel dispenser assembly. The control assembly is capable of presenting information to a customer, comprising at least audio information. The control assembly is also configured to detect surrounding noise and to adjust a volume of the audio information in response to the detected surrounding noise.

In various embodiments, the information can be audio and video information. The control assembly can include a transducer that emits the audio information. The transducer can be a membrane speaker. The control assembly can also include a transducer for detecting the surrounding noise.

### BRIEF DESCRIPTION OF DRAWINGS

The invention will be more fully understood from the following detailed description taken in conjunction with the accompanying drawings, in which:

FIG. 1 is a perspective view of a fuel dispenser;

FIG. 2 is an exemplary process flow for one embodiment of a fuel dispenser; and

FIG. 3 is an exemplary process flow for another embodiment of a fuel dispenser.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

In general, methods and devices are provided for adapting the sound produced by a fuel dispensing device. In an exemplary embodiment, the methods and devices are used in fuel dispensing devices for providing fuel to a vehicle. However, the methods and devices can be utilized in any fuel dispensing device.

As an exemplary embodiment, a fuel dispenser is provided that generally includes a housing containing various components for dispensing fuel, including a hose coupled to the housing with a nozzle located on a terminal end of the hose. The housing includes a graphical display located for outputting information to a customer. The information can include audio and/or video information. In an exemplary embodiment, the graphical display can be configured to detect surrounding noise and to adapt and/or adjust a volume of the audio information in response to the detected surrounding noise. The graphical display can adjust the volume on a sliding scale depending on a noise level of the surrounding noise, for example by increasing the volume when the surrounding noise is loud and decreasing the volume when the surrounding noise is quiet. A signal-to-noise ratio can be set for the graphical display to ensure that the volume of the audio information is adjusted to a selectable ratio when compared to the surrounding noise. A user can remotely or directly adjust the ratio, setting a default value at an intermediate level, and a maximum value and a minimum value at a maximum level and a minimum level, respectively. The volume can be adjusted to have different sensitivity based on the information output to the customer. For example, a louder or softer sound increase or decrease can be provided depending on what is played. Some information can be output at a greater volume, allowing the information to stand out more because of the increased volume. This ratio may allow the audio information to be discernable. The ability to adjust the volume of the audio information may allow the customer to hear the audio information during periods of increased background noise and it can avoid excessively loud audio from being transmitted during quieter time periods. For example, if the fuel dispenser is located in a noisy location or a location that has noisy time periods, the customer will still be able to hear the information outputted by the fuel dispenser without the surrounding noise overwhelming the information because the graphical display can increase a volume of the audio information. However, in a quieter location or during a quieter time period, the information may be output at a lower volume to prevent the information from being so loud as to disturb anyone in the vicinity. Equally, the same graphical display may output the information at a louder volume during a busier time of day, for example during rush hour, and at a lower volume during a less busy time of day, for example in the evening.

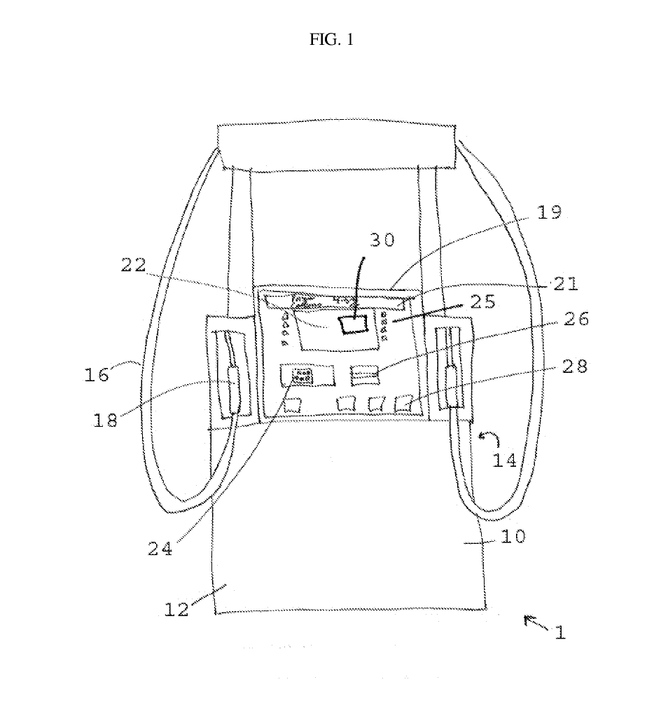

FIG. 1 illustrates one embodiment of a fuel dispenser 1 that generally includes a housing base 10 having a front side 12 and a back side 14. While only the front side 12 is discussed herein, the back side 14 can also have similar features. In general, the housing base 10 contains hydraulic(s) (such as fuel pump(s)), meter(s), and tube arrangement(s) (not shown) for transportation of fuel to one of more hoses and nozzles. The illustrated dispenser 1 has two hoses 16, each having a nozzle 18 located at a terminal end of the hose 16. However, the fuel dispenser 1 can have any number of hoses. A control system (not shown) can be disposed in the housing base 10 and is coupled to the hydraulic(s), meter(s), and tube arrangement(s). An electronics module 19 is disposed on the housing base 10 and is coupled to the control system. The electronics module 19 can include a processor and it can control the hydraulics in the housing base 10 through the control system, allowing fuel to be dispensed via each nozzle 18.

The illustrated electronics module 19 has a price and volume display 21 that presents information concerning the price and volume of any fuel being dispensed, and a graphical display 22 that presents a user interface for displaying information to a customer and/or for interacting with a customer. The illustrated electronics module 19 also has a keypad 24 and buttons 25 that allow the user to interact with the electronics module 19, a credit card slot 26 that allows the user to pay for purchases, and grade selection buttons 28 that allow the user to select the grade of fuel to be dispensed by the fuel dispenser 1. While only one fuel dispenser 1 is shown, one or more fuel dispensers 1 can be grouped together in a single location. Additionally, the fuel dispenser 1 can contain more than one hose 16 and nozzle 18 combination. For example, four hoses 16 and nozzles 18 can be provided for use on the front side 12 of the housing base 10 while four hoses 16 and nozzles 18 can be provided for use on the back side 14. A person skilled in the art will further appreciate that the fuel dispenser can have a variety of configurations and the illustrated dispenser configuration is merely representative of one type of fuel dispenser.

As indicated above, the graphical display 22 is located on the electronics module 19 on the front side 14 of the housing base 10. The graphical display 22 presents information to a customer in the form of audio and/or video. The information presented can be any information capable of being reduced to audio and/or video and is not limited to any one format. For example, the information can present commercials with synchronized audio and video used to promote products, instructions regarding using the dispenser, instructions or communications to and from the station, etc. The information can be arranged in any streaming format. For example, the information can be a continuous stream of audio and video, a predetermined loop of audio and video that repeats continuously, or a predetermined loop of audio and video that plays once and stops. The information can be synchronized across multiple fuel dispensers 1 in one location or multiple locations. The information can also be individualized to one fuel dispenser 1. The information can play continuously or can be triggered to play by an event, for example by an interaction between the customer and the fuel dispenser 1.

In one embodiment, the graphical display 22 can be interactive with the customer by incorporating a touch screen. The touch screen is electronically coupled to the graphical display 22 and overlays the graphical display 22 to allow the customer to interact with the graphical display 22. The graphical display 22 provides graphics prompts, which the customer actuates by touching the corresponding location on the touch screen. While the graphical display 22 uses a touch screen, any type of input device can be used to allow the customer and the graphical display 22 to interact. For example, the electronics module and/or housing and/or the graphical display 22 can contain one or more buttons, switches, keyboards, motion sensors, pressure sensors, sound sensors, and/or video cameras electronically coupled to the graphical display 22 directly and/or wirelessly.

In one embodiment, the graphical display 22 includes a glass screen over the graphical display 22. A sound transducer 30 is placed on the glass screen of the graphical display 22 and is electronically coupled to the graphical display 22. The sound transducer 30 can function to either or both act as a microphone that detects the surrounding noise and act as a speaker that outputs the audio information of the graphical display 22 to the customer. The graphical display 22 and the sound transducer 30 communicate back and forth in the form of signals. The sound transducer 30 shown in FIG. 1 is a membrane speaker, such as an exciter speaker that vibrates the glass panel over the graphical display 22. However, any transducer capable of producing audible noise can be used. Additionally, while the illustrated embodiment of FIG. 1 shows one sound transducer 30 that is capable of both detecting surrounding noise and outputting the audio information to a customer, more than one transducer can be used. For example, a first transducer can be used to detect the surrounding noise, for instance by being used as a microphone. A second transducer can be used to output the audio information to the customer, for example by being used as a speaker. Also, while the sound transducer 30 is positioned on the graphical display 22 on the housing base 10, the transducer(s) can be positioned anywhere on or surrounding the fuel dispenser 1. The transducer(s) can be electronically coupled to the graphical display 22 directly and/or wirelessly, and the signals between the transducer(s) and the graphical display 22 may be sent directly and/or wirelessly.

Multiple transducers can operate together to maximize a sound output. For example, transducers on the front side 12 and the back side 14 of the fuel dispenser 1 can operate in unison to further increase the volume. Multiple transducers can additionally or alternatively operate together regarding timing of sharing information. For example, a customer on the front side 12 can begin to interact with the dispenser 1 and a commercial can start to be shared through a first transducer. If a second customer subsequently begins to interact with the back side 14 and information is shared through a second transducer, timing can be matched between the first and second transducers so as not to disturb each customer and to prevent multiple transducers from increasing volume to be louder than other transducers. Coordination of timing and/or volume between multiple transducers can apply within one dispenser and/or across multiple dispensers.

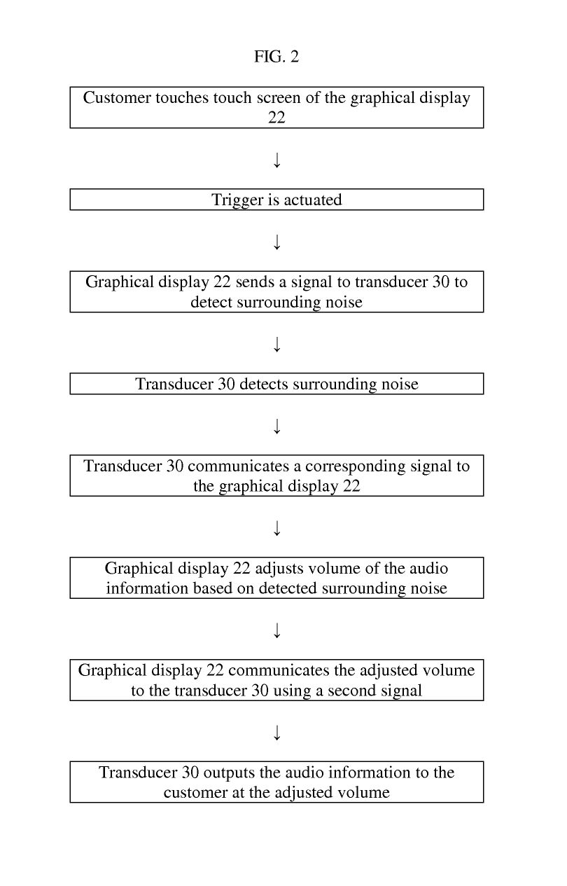

The graphical display can detect surrounding noise and it can adjust a volume of the audio information up or down in response to the detected surrounding noise. For example, the graphical display can be electronically coupled to a trigger. Activation of the trigger can activate the graphical display, causing the graphical display to detect the surrounding noise by a transducer coupled to the trigger and to output information to a customer. The graphical display 22 of FIG. 1 detects the surrounding noise upon activation of a trigger on and coupled to the graphical display 22. In an exemplary embodiment in FIG. 2, the customer touches the touch screen of the graphical display 22. This touch by the customer of the touch screen of the graphical display 22 acts as the trigger, the actuation of which causes the graphical display 22 to send a signal to the sound transducer 30 to detect the surrounding noise. The sound transducer 30 detects the surrounding noise and communicates a corresponding signal to the graphical display 22. The graphical display 22 adjusts the volume of the audio information based on the detected surrounding noise and communicates the adjusted volume to the sound transducer 30 using a second signal. The sound transducer 30 outputs the audio information to the customer at the adjusted volume. While the sound transducer 30 in the illustrated embodiment both detects the surrounding noise and outputs the adjusted audio information to a customer, one or more transducers can be used to detect the surrounding noise and present the adjusted audio information to the customer. Also while the trigger of FIG. 2 represents a touch of the touch screen of the graphical display 22 by the customer, the trigger can be any event capable of causing the graphical display 22 to require detection of the surrounding noise. For example, the trigger can be an actuation of one or more buttons, switches, keyboards, motion sensors, pressure sensors, sound sensors, and/or video cameras placed on or surrounding fuel dispenser 1. The trigger can also be actuated by payment by the customer using the credit card slot 26.

In other embodiments, the beginning or an end of the predetermined loop of audio and video information presented to the customer can function as the trigger. When the predetermined loop begins and/or ends outputting the information to the customer, the beginning or ending of the loop can trigger the sound transducer 30 to detect the surrounding noise and communicate the corresponding signal to the graphical display 22, proceeding through the remaining steps shown in FIG. 2. The trigger can be electronically coupled to the graphical display 22 directly and/or wirelessly and can send and receive signals to and from the graphical display 22 directly and/or wirelessly.

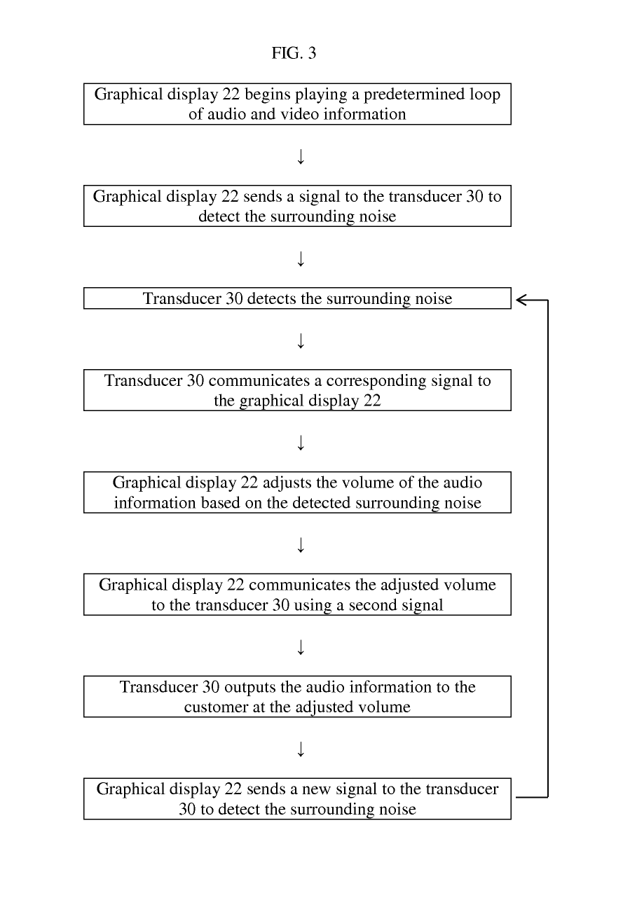

The graphical display can also cause continuous detection of surrounding noise and it can continuously adjust a volume of audio information up or down depending on noise levels of surrounding noise. In the embodiment of FIG. 3, the graphical display 22 begins to play a predetermined loop of audio and video information. The graphical display 22 sends a signal to the sound transducer 30 to detect the surrounding noise. The sound transducer 30 detects the surrounding noise and communicates a corresponding signal to the graphical display 22. The graphical display 22 adjusts the volume of the audio information based on the detected surrounding noise and communicates the adjusted volume to the sound transducer 30 using a second signal. The sound transducer 30 outputs the audio information to the customer at the adjusted volume. The graphical display 22 sends a new signal to the sound transducer 30 to detect the surrounding noise, and the cycle repeats. Again, one or more transducers can be used to detect the surrounding noise and present the adjusted audio information to the customer. Also while the graphical display 22 continuously plays a predetermined loop of audio and video information, the graphical display 22 can cause continuous volume adjustment of any audio information. For example, the graphical display can cause continuous volume adjustment of a continuous stream of audio and video or a predetermined loop of audio and video that plays once and stops. Additionally, the graphical display can continuously adjust volume of audio information that began to play due to activation of the trigger.

The graphical display can also learn from past data to further perfect a volume of audio information presented to a customer. For example, one or more transducers electronically coupled to the graphical display can detect data about the surrounding environment, such as sound, time of day, pressure, temperature, moisture, and humidity. The data can be analyzed and/or stored by the graphical display. The graphical display can then adjust a volume of the audio information presented to the customer based on the data of the surrounding environment either at that moment or based on historical norms for that time of day, month, and/or year. The graphical display can use the past data to anticipate the surrounding noise at any point throughout a day and/or week and/or month and to adjust the audio information accordingly. The graphical display's ability to learn from past events can allow the fuel dispenser 1 to operate more effectively by anticipating needs when presenting audio information without having to constantly recheck the environment and/or surrounding noise.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A fuel dispenser for dispensing fuel to a vehicle, comprising:
a housing;
a hose coupled to the housing and having a nozzle located on a terminal end thereof;
a control system in the housing for controlling the dispensing of fuel through the hose and the nozzle; and
a graphical display located on the housing for presenting information to a customer, the information comprising audio and video information, wherein the graphical display is configured to detect surrounding noise and to adjust a volume of the audio information in response to the detected surrounding noise.

2. The fuel dispenser of claim 1, wherein the graphical display includes a transducer that emits the audio information.

3. The fuel dispenser of claim 1, wherein the transducer is a membrane speaker.

4. The fuel dispenser of claim 1, wherein the graphical display includes a transducer for detecting the surrounding noise.

5. The fuel dispenser of claim 1, wherein the graphical display includes a single transducer for detecting the surrounding noise and for emitting the audio information.

6. A fuel dispenser for dispensing fuel to a vehicle, comprising:
a housing;
a hose coupled to the housing and having a nozzle located on a terminal end thereof;
a control system in the housing for controlling the dispensing of fuel through the hose and the nozzle into a vehicle;
a graphical display located on the housing for presenting information to a customer, the information comprising audio and video information;
a trigger capable of activating the graphical display to cause the graphical display to present information to the customer; and
at least one transducer coupled to the trigger and to the graphical display, the transducer being configured to detect surrounding noise in response to actuation of the trigger, and the graphical display being configured to adjust a volume of the audio information in response to the detected surrounding noise.

7. The fuel dispenser of claim 6, wherein the transducer comprises a speaker that emits the audio information.

8. The fuel dispenser of claim 7, wherein the speaker is a membrane speaker.

9. The fuel dispenser of claim 6, wherein the transducer comprises a single transducer for detecting the surrounding noise and for emitting the audio information.

10. The fuel dispenser of claim 6, wherein the trigger is configured to be actuated upon the customer interacting with the graphical display.

11. The fuel dispenser of claim 6, wherein the information comprises a continual predetermined loop of audio and video information, and wherein an end of each loop functions as the trigger to activate the graphical display.

12. A fuel dispenser for dispensing fuel to a vehicle, comprising:
a housing;
a hose coupled to the housing and having a nozzle located on a terminal end thereof;
a control system in the housing for controlling the dispensing of fuel through the hose and the nozzle into a vehicle;
a graphical display located on the housing for presenting information to a customer, the information comprising audio and video information; and
at least one transducer coupled to the graphical display, the transducer being configured to continuously detect surrounding noise, and the graphical display being configured to adjust a volume of the audio information in response to the detected surrounding noise.

13. The fuel dispenser of claim 12, wherein the transducer comprises a speaker that emits the audio information.

14. The fuel dispenser of claim 13, wherein the speaker is a membrane speaker.

15. The fuel dispenser of claim 12, wherein the transducer comprises at least one transducer configured to detect the surrounding noise, and the graphical display further comprises at least one additional transducer for emitting the audio information.

16. A fuel delivery system for fueling a vehicle, comprising:
a fuel dispenser assembly operatively arranged to controllably dispense fuel into a vehicle positioned for refueling; and
a control assembly operatively arranged to control a fuel dispensing activity of the fuel dispenser assembly, the control assembly being capable of presenting information to a customer, the information comprising at least audio information, the control assembly being configured to detect surrounding noise and to adjust a volume of the audio information in response to the detected surrounding noise.

17. The fuel delivery system of claim 16, wherein the information comprises audio and video information.

18. The fuel delivery system of claim 16, wherein the control assembly includes a transducer that emits the audio information.

19. The fuel dispenser of claim 16, wherein the transducer is a membrane speaker.

20. The fuel dispenser of claim 16, wherein the control assembly includes a transducer for detecting the surrounding noise.
